(19) United States
(12) Patent Application Publication
(10) Pub. No.: US 2017/0124608 A1
(43) Pub. Date: May 4, 2017

(54) SYSTEMS AND METHODS FOR PARKING FEE MANAGEMENT

(71) Applicant: IPT, LLC, Somerville, NJ (US)

(72) Inventor: MATTHEW SILVERMAN, UPPER MONTCLAIR, NJ (US)

(21) Appl. No.: 14/932,610

(22) Filed: Nov. 4, 2015

(51) Int. Cl. G06Q 30/02

(52) U.S. Cl. CPC G06Q 30/0284; G06Q 2240/00

(57) ABSTRACT

The disclosed technology relates to post-pay parking management for permitting customers to park in a pay-parking zone and, thereafter, remotely pay for the parking after leaving the pay-parking zone. The disclosed technology can record vehicle information for a vehicle parked in a pay-parking zone, determine that the vehicle is not registered to park in the pay-parking zone, apply a physical notice to the vehicle showing instructions for remotely making payment for parking the vehicle in the pay-parking zone, and receive a payment transaction for parking the vehicle in the pay-parking zone, after the vehicle has left the pay-parking zone.

### FIELD OF THE INVENTION

The disclosed technology relates generally to the field of parking management. In particular, the disclosed technology relates to post-pay parking management for permitting customers to park in a pay-parking zone and, thereafter, remotely pay for the parking after leaving the pay-parking zone.

### BACKGROUND OF THE INVENTION

Parking management is a challenge that has been addressed for quite some time and continues to need attention. Parking management is especially important when demand for parking outnumbers the available parking. Most parking management solutions require dedicated infrastructure and labor, such as parking garages, meters, full time service personnel, or enforcement personnel, among others. Most such solutions suffer from high capital and labor costs. Over time, infrastructure becomes outdated and requires further costs for repair or replacement. There is need for continued improvements to parking management that involve lower costs and less infrastructure and labor.

### SUMMARY OF THE INVENTION

The disclosed technology relates to post-pay parking management for permitting customers to park in a pay-parking zone and, thereafter, remotely pay for the parking after leaving the pay-parking zone. In one aspect of the disclosed technology, a computer-implemented method for parking management includes recording by an electronic storage vehicle information for a vehicle parked in a pay-parking zone, determining by a processor that the vehicle is not registered to park in the pay-parking zone, applying a physical notice showing instructions for remotely making payment for parking the vehicle in the pay-parking zone, where the payment is to be made remote from the pay-parking zone and the physical notice is configured to be placed on the vehicle, and receiving at a computer a payment transaction for parking the vehicle in the pay-parking zone, after the vehicle has left the pay-parking zone.

In one embodiment, the disclosed technology includes communicating to a driver of the vehicle instructions for remotely making payment for parking the vehicle in the pay-parking zone, where the communication includes the physical notice placed on the vehicle and excludes mailing any notice to the owner of the vehicle. In one embodiment, the disclosed technology includes accessing historical information for the vehicle, determining that the vehicle is delinquent in payment of at least one parking fee, and generating the physical notice to reflect severity of the delinquency.

In one aspect of the disclosed technology, the pay-parking zone is a sign-less and meter-less parking zone, and the physical notice shows at least one of parking rates and parking rules for the pay-parking zone. In one embodiment, the disclosed technology includes changing at least one of the parking rates and the parking rules between a high parking season and a low parking season.

In one aspect, the disclosed technology includes recording by the electronic storage vehicle information for a second vehicle parked in the pay-parking zone, and determining by the processor that the second vehicle is associated with a landlord that is registered with the pay-parking zone, where the second vehicle is designated as a vehicle of a tenant of the landlord.

In one aspect, the disclosed technology includes recording by the electronic storage vehicle information for a second vehicle parked in the pay-parking zone, and determining by the processor that the second vehicle is registered to park in the pay-parking zone. In one embodiment, the disclosed technology includes a second physical notice configured to be placed on the second vehicle, where the second notice shows information regarding at least one of: special event, discount program, parade, parking policy change and construction.

In one embodiment, the disclosed technology includes receiving at the computer an indication that the physical notice is validated by a merchant so that the payment transaction is made by the merchant for at least a portion of the payment. In one embodiment, the disclosed technology includes receiving at the computer an indication that responsibility for making payment for parking the vehicle in the pay-parking zone is to be handled by a particular entity so that the payment transaction is made by the particular entity.

In one aspect of the disclosed technology, a system for parking management includes an electronic storage that contains vehicle information for a vehicle parked in a pay-parking zone, a processor configured to determine that the vehicle is not registered to park in the pay-parking zone, a physical notice configured to be placed on the vehicle showing instructions for remotely making payment for parking the vehicle in the pay-parking zone, where the payment is to be made remote from the pay-parking zone, and a computer configured to receive a payment transaction for parking the vehicle in the pay-parking zone, after the vehicle has left the pay-parking zone.

In one embodiment, the system excludes any mailing to the owner of the vehicle. In one embodiment, the processor is further configured to access historical information for the vehicle and determine that the vehicle is delinquent in payment of at least one parking fee, and a parking personnel device can be configured to generate the physical notice to reflect severity of the delinquency.

In one aspect of the disclosed technology, the pay-parking zone is a sign-less and meter-less parking zone, and the physical notice shows at least one of parking rates and parking rules for the pay-parking zone. In one embodiment, the parking rates can differ between a high parking season and a low parking season and the parking rules can differ between a high parking season and a low parking season.

In one aspect of the disclosed technology, the electronic storage further includes vehicle information for a second vehicle parked in the pay-parking zone, and the processor is further configured to determine that the second vehicle is associated with a landlord that is registered with the pay-parking zone, where the second vehicle is designated as a vehicle of a tenant of the landlord.

In one aspect of the disclosed technology, the electronic storage further includes vehicle information for a second vehicle parked in the pay-parking zone, and the processor is further configured to determine that the second vehicle is registered to park in the pay-parking zone. In one embodiment, a second physical notice can be configured to be placed on the second vehicle, showing information regarding at least one of: special event, discount program, parade, parking policy change and construction.

In one embodiment, the computer is configured to receive an indication that the physical notice is validated by a merchant so that the payment transaction is made by the merchant for at least a portion of the payment. In one embodiment, the computer is configured to receive an indication that responsibility for making payment for parking the vehicle in the pay-parking zone is to be handled by a particular entity so that the payment transaction is made by the particular entity.

Other advantages and features of the disclosed technology will become more apparent in the detailed description and accompanying drawings.

### BRIEF DESCRIPTION OF THE DRAWINGS

Reference is made to the accompanying drawings, in which:

FIG. 1 is a block diagram of an exemplary system for parking management in accordance with the disclosed technology;

FIG. 2 is a flow diagram of an exemplary vehicle monitoring process in accordance with one aspect of the disclosed technology;

FIG. 3 is a flow diagram of an exemplary vehicle registration process in accordance with the disclosed technology;

FIG. 4 is a flow diagram of an exemplary vehicle noticing process in accordance with the disclosed technology;

FIG. 5 is a flow diagram of an exemplary payment process in accordance with the disclosed technology;

FIG. 6 is a flow diagram of an exemplary process for associating a particular notice with a particular vehicle or parking fee;

FIG. 7 is a flow diagram of an exemplary process for enforcing parking fees; and

FIG. 8 is a block diagram of exemplary components in the devices of the disclosed technology.

### DETAILED DESCRIPTION

The disclosed technology relates to post-pay parking management for permitting customers to park in a pay-parking zone and, thereafter, remotely pay for the parking after leaving the pay-parking zone. Because the disclosed post-pay parking management system and method do not require a parking customer to provide payment at the parking location, the disclosed technology involves significant cost savings for managing parking locations. For example, parking meters, pay stations, and parking attendants, may not be necessary for the disclosed parking management system and method.

In one aspect of the disclosed technology, vehicles parked in a parking zone may be intermittently monitored by parking management personnel using electronic devices and/or mobile electronic devices. The electronic devices can communicate with a host computer system that can maintain a record of the parked vehicles and can accept electronic payment for parking fees associated with the vehicles. Parking management personnel can apply physical notices to vehicles parked in the parking zone with information about parking rates and with instructions about remotely paying for parking. Thus, in one aspect of the disclosed technology, parking management personnel do not need to be constantly on location at the parking zone.

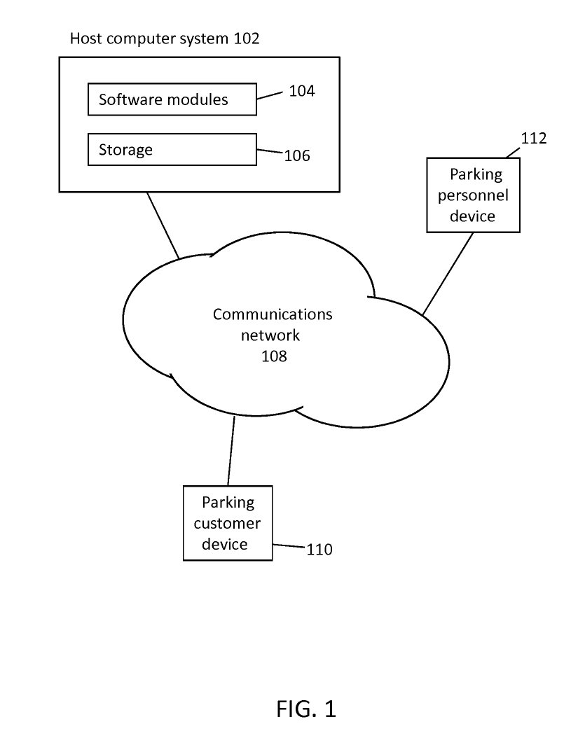

Referring now to FIG. 1, there is shown a block diagram of an exemplary parking management system in accordance with the disclosed technology. The illustrated parking management system can include a host computer system 102 that includes various software modules 104 and storage 106. The host computer system 102 can be connected to a communication network 108, which can include one or more wired or wireless communication networks such as POTS, cable, fiber optic, cellular, WiFi, satellite, or any other wired or wireless communication network or communications protocol. Other devices can be connected to the communication network 108, such as parking customer devices 110 or parking management personnel devices 112, which will be described in more detail later herein.

In one embodiment, the storage 106 of the host computer system 102 can store information regarding parking zones. As used herein, a parking zone can be any location and space that can accommodate parking of multiple vehicles. A parking zone can be a parking lot or parking garage but may also be any street or field or space that can accommodate vehicle parking. The storage 106 can store, for example, the name and location of a parking zone and various information about the parking zone, such as number of vehicles the zone can accommodate, times during which parking in the zone is permitted or limited or prohibited, parking rates, and information about vehicles that are registered to park in the zone, among other things. As discussed in more detail later herein, the storage 106 can also store information regarding vehicles that have been recorded as being parked in the parking zone, such as license plates and times at which vehicles are observed to be parked in the parking zone.

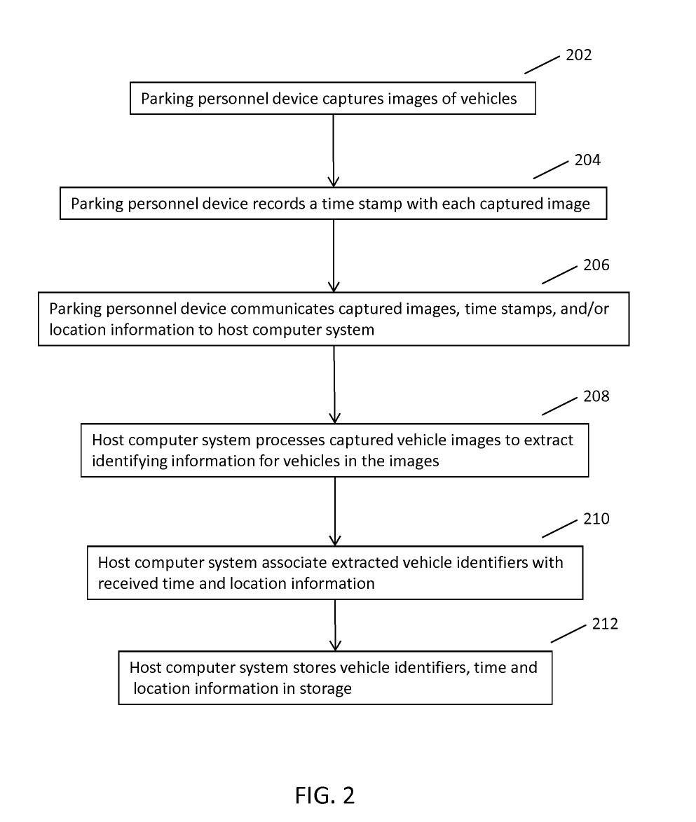

Referring now to FIG. 2, there is shown a flow diagram of an exemplary vehicle monitoring process in accordance with one aspect of the disclosed technology. In one aspect of the disclosed technology, parking patrons can arrive at and depart a parking zone as desired. Parking management personnel for the parking zone may be on-location at the parking zone intermittently or may be on location at the parking zone full time during particular time periods, as desired. Parking management personnel can be equipped with one or more electronic devices (FIG. 1, 112). The parking personnel devices can have communication and image capture capabilities and other capabilities. The parking personnel devices can capture images of vehicles parked in the parking zone (202) and can communicate the images to the host computer system (FIG. 1, 102). The images of the vehicles can be images of entire vehicles or images of vehicle portions, such as a license plate or other information which can be used to identify the vehicle. The parking personnel devices can record a time stamp (204) with each captured image and communicate the time stamp to the host computer system. In one embodiment, the parking personnel devices can communicate to the host computer system information to identify the parking zone location, such as a name or other identification of the parking zone. In one embodiment, the parking personnel devices can include a GPS receiver and can associate a GPS location reading with capture images. The captured images, time stamps, and/or location information can be communicated to the host computer system (206) through the communications network (FIG. 1, 108). The host computer system can have one or more software modules (FIG. 1, 104) that receive and process this information. In one embodiment, parking management personnel can intermittently capture images of vehicles parked in the parking zone, such as capturing images every hour or every thirty minutes or any other time interval as desired. If the size of the parking zone is appropriate, the parking personnel devices can be handheld devices that parking personnel can hand-carry and use while walking or moving through the parking zone. If the parking zone is large, the parking personnel devices can be mounted to a parking personnel vehicle and can capture images of parked vehicles as the parking personnel vehicle travels through the parking zone. Examples of vehicle mounted parking personnel devices are described in U.S. Patent Application Publication No. US2012-0215596A1, the entire contents of which are hereby incorporated by reference herein.

The host computer system can receive vehicle images and time and location information from the parking personnel devices (206). The host computer system can have one or more software modules (FIG. 1, 104) that receive and process this information. The host computer system software modules can process the captured vehicle images to extract identifying information for the vehicles in the images (208). For example, if the captured image contains a license plate, then license plate recognition (“LPR”) technology can be used to determine the license plate issuing state and the license plate number. LPR technology is described in U.S. Pat. No. 7,843,321 and in U.S. Patent Application Publication No. US2012-0215596A1, the entire contents of which are hereby incorporated by reference herein. Using LPR to identify a vehicle is merely exemplary, and other ways to identify a vehicle in an image is contemplated to be within the scope of the disclosed technology. The host computer system can associate the extracted vehicle identifiers with time and location information received from the parking personnel device (210) and can store this information (212) in its storage (FIG. 1, 106).

The embodiments illustrated and described in connection with FIG. 2 are exemplary. Processes or features described as being performed by the host computer system can be performed by the parking personnel device, and processes or features described as being performed by the parking personnel device can be performed by the host computer system. For example, the parking personnel device can include LPR technology that extract vehicle identifying information from images.

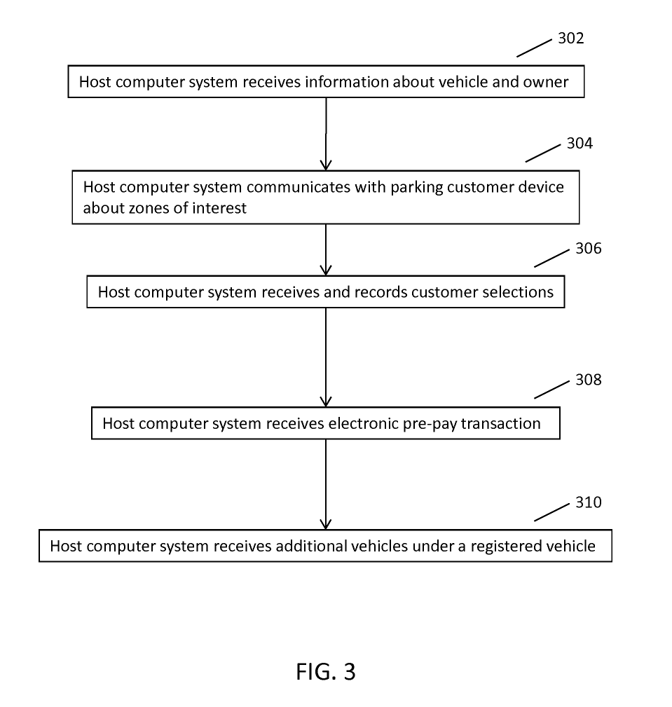

In one aspect of the disclosed technology, a parking zone may permit parking customers to register their vehicle with the host computer system to pre-pay for rights to park in the parking zone. FIG. 3 is a flow diagram of an exemplary vehicle registration process in accordance with the disclosed technology. A parking customer device (FIG. 1, 110) can communicate with the host computer system. The host computer system can have one or more software modules (FIG. 1, 104) that handle vehicle registration. The host computer system can receive information about the vehicle owner, such as name, residential address, and payment account information, and can receive information about the vehicle, such as vehicle make, model, year, VIN number, license plate issuance state, and/or license plate number (302). The host computer system can communicate with the parking customer device about one or more parking zones of interest to the customer (304). For example, the host computer system can include a search feature that allows parking customers to search for and select parking zones of interest. The host computer system can present parking rates and parking times to the parking customer device. The parking customer can submit its selections to the host computer system, which can receive and record the selections (306). The parking customer can pre-pay for the parking using an electronic transaction, such as a credit card transaction or an ACH transaction (308). Other aspects of electronic registration of vehicles are described in U.S. Patent Application Publication No. US2012-0215595A1, which is hereby incorporated by reference in its entirety.

In one aspect of the disclosed technology, a vehicle that is registered with the host computer system can designate itself as a landlord, employer, or another position. The host computer system can permit a registered vehicle to have additional vehicles under its account (310). For example, tenant vehicles can be added under a landlord vehicle's registered account and can be designated as tenant vehicles. As another example, employee vehicles can be added under an employer vehicle's registered account and can be designated as employee vehicles. In one embodiment, payment of parking fees associated with added vehicles can be paid through the registered account. Accordingly, parking fees for tenant vehicles can be pre-paid through the landlord vehicle's registered account, and parking fees for employee vehicles can be pre-paid through the employer vehicle's registered account.

In one aspect of the disclosed technology, vehicle drivers can be notified about parking rates and parking times by physical notices placed on the parked vehicles by parking management personnel. Notices may also be given directly to drivers when there is opportunity to do so. In one embodiment, when parking management personnel are present at entry, a notice may be provided to the vehicle driver upon entry into the parking zone. In one embodiment, parking management personnel can place notices on the vehicles as they patrol the parking zone. In one embodiment, the notices are configured to be informative rather than threatening. The notices can inform a vehicle driver about parking rates, parking times, and instructions for paying the parking fee after leaving the parking zone.

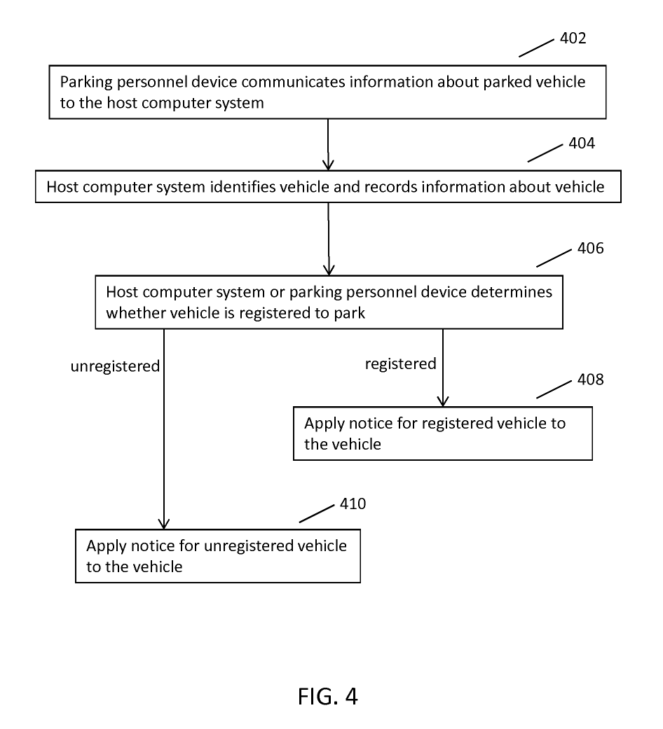

Referring now to FIG. 4, there is shown a flow diagram of an exemplary vehicle noticing process in accordance with the disclosed technology. As described above herein, a parking personnel device can communicate information about a parked vehicle to the host computer system (402), and the host computer system can identify and record information about the vehicle in its storage (404). In one embodiment, the host computer system or the parking personnel device can determine whether the vehicle is registered to park in the parking zone (406). As described above herein, the host computer system can maintain information on vehicles registered to park in a parking zone. If the host computer system determines that the vehicle is registered, it can communicate the determination to the parking personnel device. In one embodiment, the host computer system may communicate a list of registered vehicles to the parking personnel device, and the parking personnel device can use the list to determine whether a vehicle is registered to park in the parking zone. In one embodiment, if a vehicle is registered to park in the parking zone, no notice is needed for the vehicle, but a notice can be applied to the vehicle with reminders about registration expiration and renewal (408). In one embodiment, if a vehicle is not registered to park in the parking zone, a notice may be applied to the vehicle to explain parking rates, parking times, and instructions for paying the parking fee after leaving the parking zone (410). In any case, the notice can include information about local events, advertising and promotions, parking rule changes, among other things.

In one embodiment, the notices can be wholly pre-generated away from the parking zone. For example, a notice can be pre-printed with information about parking rates, parking times and rules, instructions for remotely making payment, and/or advertising and promotional information. In one embodiment, the notices can be partially pre-generated away from the parking zone and can be partially printed at the parking zone. For example, in one embodiment, notices can be pre-printed with certain information, such as parking zone location information and instructions for making payment, but the notice can provide space for other information to be added on-location at the parking zone, such as parking rates, advertising, registration reminders, among other things. In this manner, for example, if parking rates are changed from time to time, the notices can reflect the most updated parking rates. For information to be printed onto the notice on-location at the parking zone, the parking personnel devices can have printing capability. In one embodiment, the parking personnel device can communicate with the host computer system to obtain any information to be printed onto the notices. The host computer system can store information such as parking rates, parking times, parking regulations and rules, advertising and promotional information, local events, and registration information, and can communicate the information to the parking personnel device for printing onto the notices. In one embodiment, the host computer system can identify a vehicle parked in the parking zone based on information received from the parking personnel device and can tailor the information to be communicated to the parking personnel device for printing onto a notice. For example, if the identified vehicle is registered to park in the parking zone, the host computer system can retrieve the vehicle's registration information and can send a registration reminder to the personnel printing device for printing.

The embodiments illustrated and described in connection with FIG. 4 are exemplary. Processes or features described as being performed by the host computer system can be performed by the parking personnel device, and processes or features described as being performed by the parking personnel device can be performed by the host computer system. For example, the parking personnel device can store information such as parking rates, parking times, parking regulations and rules, advertising and promotional information, local events, and registration information, for printing onto notices.

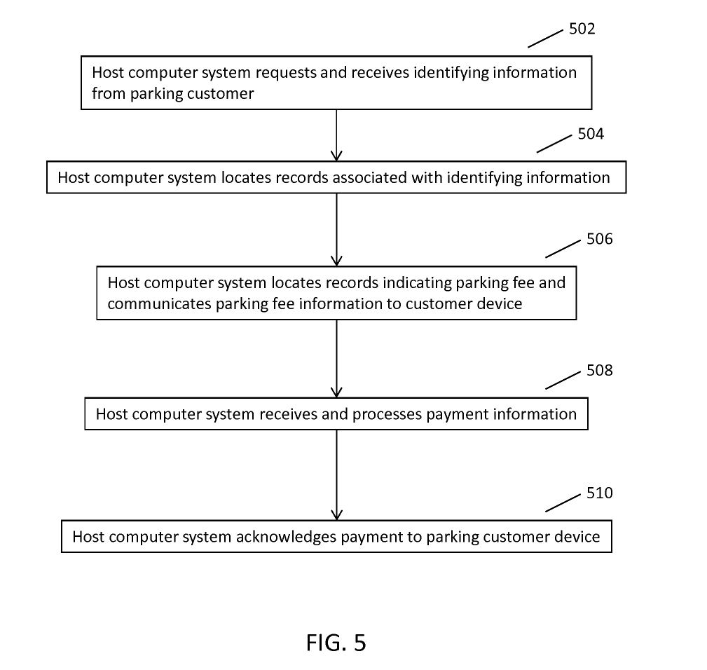

Referring now to FIG. 5, there is shown a flow diagram of an exemplary payment process in accordance with the disclosed technology. The host computer system can include software modules (FIG. 1, 104) that handle payment processing. In one aspect of the disclosed technology, a parking customer can communicate with the host computer system using a telephone, a cellular phone, a smartphone, a computer, a laptop, a tablet, or any other telephonic or computing device. In one embodiment, the parking notice can indicate a telephone number that can be used to make payment, and the parking customer can call the telephone number. In one embodiment, the parking notice can indicate a website that can be used to make payment, and the parking customer can access the website. The host computer system can request identifying information from the parking customer, such as a license plate number, VIN number, or other information by which to identify the vehicle at issue (502). The parking customer can communicate the identifying information to the host computer system (502). If the parking customer is using a telephonic device, the parking customer can enter telephone tones or speak the identifying information. If the parking customer is using a computing device, the parking customer can enter identifying information via a physical keyboard or a virtual on-screen keyboard. Other input devices or technologies can also be used. The host computer system can use the identifying information received from the parking customer to locate records associated with that identifying information (504). If no records are located, the host computer system can prompt the user to again provide identifying information. If the host computer system locates records indicating that one or more parking fees are due, the host computer system can communicate information about the parking fee to the parking customer device (506).

The host computer system can compute parking fees before a payment transaction or compute a parking fee during a payment transaction. The host computer system can access its records to determine the times at which a vehicle was observed as being parking in the parking zone. The host computer system can apply the parking rates for the parking zone to those times to determine a parking fee. For example, if the parking rate is $3.00 for any fraction or whole of an hour, and a vehicle was observed at 1:28 PM and at 2:31 PM, then the host computer system can determine that the vehicle parked for portions of two separate hours and compute the parking fee as $6.00. In one embodiment, the host computer system can compute parking fees daily or every few hours or using another frequency.

The host computer system can communicate the fee information to the parking customer (506). If the parking customer is using a telephonic device, the host computer system can communicate the fee information telephonically. If the parking customer is using a computing device, the host computer system can communicate the fee information to the parking customer device to be displayed. The fee information can include, for example, location or name of the parking zone and the date of the parking, among other things. The parking customer can submit payment information, such as credit card payment information, debit card payment information, ACH payment information, or other account information or code (508). If the parking customer is using a telephonic device, the parking customer can enter telephone tones or speak the payment information. If the parking customer is using a computing device, the parking customer can enter payment information via a physical keyboard or a virtual on-screen keyboard. Other input devices or technologies can also be used. The host computer system can receive the payment information and process the payment (508). If the payment processing is unsuccessful, the host computer system can prompt the parking customer to again provide payment information. If the payment processing is successful, the host computer system can acknowledge payment to parking customer (510).

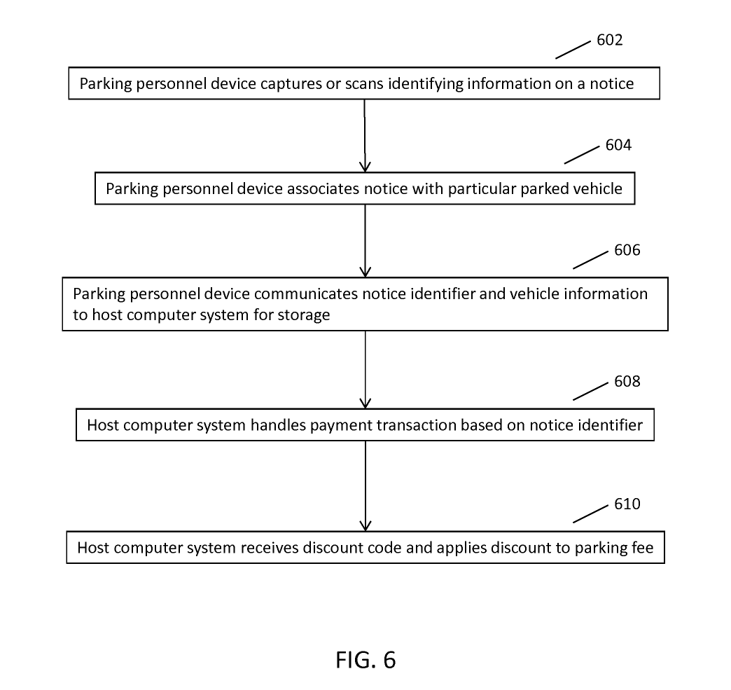

Referring now to FIG. 6, there is shown a flow diagram of an exemplary process for associating a particular notice with a particular vehicle or parking fee. In one aspect of the disclosed technology, a parking notice may have identifying information, such as a notice number or a bar code. In one embodiment, the parking personnel device can capture or scan the identifying information on a notice (602) and can associate the notice with information for a particular vehicle parked in the parking zone (604). The parking personnel device can communicate the notice identifier to the host computer system along with information about the vehicle for storage in the host computer system (606). When a parking customer contacts the host computer system to pay the parking fee, the parking customer can submit the notice identifier to the host computer system, which can identify the parking fee based on the notice identifier (608). In this embodiment, any person who has the notice identifier can pay the parking fee. For example, if a restaurant or any other merchant wishes to pay the parking fee for its customers, the customer can provide the notice or notice identifier to the restaurant or merchant, which can contact the host computer system to pay the parking fee associated with the notice. In one embodiment, certain restaurant or merchants may receive a discount when they pay a customer's parking fee. In one embodiment, the discount can be applied by a discount code during payment of a parking fee (610). In one embodiment, if a restaurant or any other merchant wishes to pay the parking fee for its customers, it may communicate this arrangement to the host computer system. The host computer system can record this arrangement so that the restaurant/merchant can be reminded about unpaid parking fees instead of the customer being reminded.

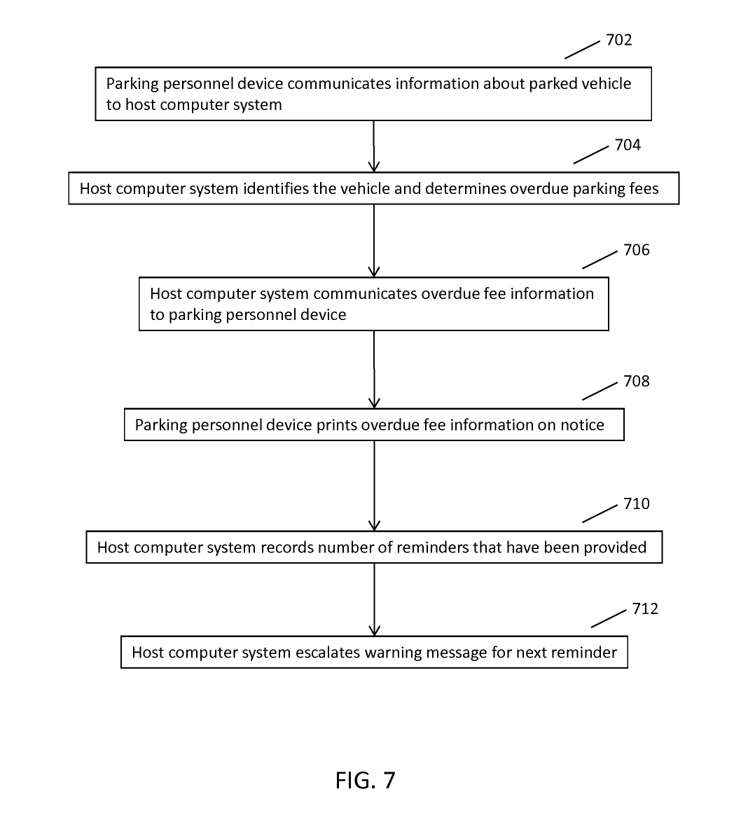

Referring now to FIG. 7, there is shown an exemplary process of enforcing parking fees. The host computer system can determine when parking fees are overdue. In one aspect of the disclosed technology, on-vehicle notices are used to inform vehicle drivers of overdue parking fees. A parking personnel device can communicate information about a parked vehicle to the host computer system (702). The host computer system can identify the vehicle and determine whether there are any overdue parking fees associated with the vehicle (704). If so, the host computer system can communicate the overdue fee information to the parking personnel device to be printed onto a notice (706, 708). The parking personnel can apply the notice to the vehicle or provide it to the driver, thereby informing the driver of the outstanding parking fee. The host computer system can record the number of reminders that have been provided (710). In one embodiment, second and subsequent reminder messages can escalate in warnings (712). For example, after a certain number of reminders, the next reminder message can include a warning about the vehicle being booted. Vehicle booting is described in U.S. Pat. No. 7,988,046, the contents of which are hereby incorporated by reference in their entirety. In one embodiment, if a particular number of reminders and warnings have been provided, the host computer system can provide a message to the parking personnel device instructing the parking personnel to boot the vehicle.

The embodiments illustrated and described in connection with FIG. 7 are exemplary. Processes or features described as being performed by the host computer system can be performed by the parking personnel device, and processes or features described as being performed by the parking personnel device can be performed by the host computer system. For example, the parking personnel device can determine whether to escalate warnings and determine the appropriate action to be taken.

What have been described thus far are systems and methods for monitoring vehicles parked within a parking zone, providing notices on parked vehicles, computing parking fees, enforcing payment of parking fees, and receiving payment of parking fees. Because the disclosed technology permits parking customers to pay for parking after leaving a parking zone, infrastructure and labor costs are reduced because payment facilities and cashiers are not needed at the parking zone, such as parking meters. Additionally, because parked vehicles can be monitored intermittently, there is no need for parking personnel to be on-location full-time at the parking zone. Communicating with vehicle drivers by on-vehicle notices provides benefits in that the communication is immediate and the message directly reaches the vehicle driver. In one embodiment of the disclosed technology, there are no physical mailings sent to vehicle owners. Additionally, with on-vehicle notices, the parking zone does not need to have signs that post parking rates, times, and regulations. Changes in parking rates or rules can be indicated on the notices, and other information of interest or advertisements can also be included on the notices.

The disclosed solution can be especially helpful for parking zones that experience large variations in parking demand between seasons. Because of large variations between seasons, dedicated infrastructure and personnel and may be unsuitable for the parking zone, and parking rates may vary depending on seasonal demand. The disclosed technology involves reduced infrastructure and personnel and allows parking customers to be informed about changes in parking rates.

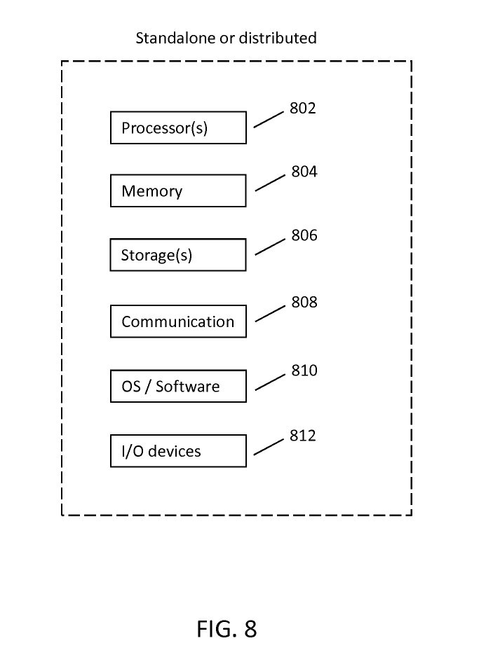

Referring again to FIG. 1, the host computer system 102, parking customer device 110, and parking personnel device 112 can be standalone or distributed systems and devices. Referring also to FIG. 8, there is shown a block diagram of an exemplary system or device in accordance with the disclosed technology. The host computer system, parking customer device, and parking personnel device can include one or more processors 802, memory 804, and storages 806, located together in one location or networked across different locations. For example, the host computer system can include one or more servers in one location or can include multiple servers distributed across different locations. The storage 806 can include any kind of storage, such as magnetic hard disk storage and/or solid state storage, among others. The host computer system, parking customer device, and parking personnel device can include communication technology, such as any kind or combination of wired or wireless communication technologies, including Ethernet, cable, fiber optic, WiFi, 4G, GSM, or any other wired or wireless communication technology. The host computer system, parking customer device, and parking personnel device can include operating system software and other software 810, including software for the technology described herein. The host computer system, parking customer device, and parking personnel device can include input/output devices 812, such as display screens, speakers, microphones, keypads, touchscreens, keyboards, mice, or any other kind of or combination of input or output device.

While certain embodiments of the disclosed technology have been illustrated and described, they are merely exemplary and do not limit the scope of the disclosed technology. Various modifications and combinations are contemplated to be within the scope of the disclosed technology, even if not illustrated or described. For example, processes or features described as being performed by the host computer system can be performed by the parking personnel device, and processes or features described as being performed by the parking personnel device can be performed by the host computer system. It is intended that the disclosed technology not be limited to the exact embodiments described and illustrated, but should be construed to cover all variations and/or modifications that may fall within the scope of the claims.

What is claimed is:

1. A computer-implemented method for parking management, comprising:
recording, by an electronic storage, vehicle information for a vehicle parked in a pay-parking zone;
determining, by a processor, that the vehicle is not registered to park in the pay-parking zone;
applying a physical notice, showing instructions for remotely making payment for parking the vehicle in the pay-parking zone, the payment to be made remote from the pay-parking zone, the physical notice configured to be placed on the vehicle; and
receiving, at a computer, a payment transaction for parking the vehicle in the pay-parking zone, after the vehicle has left the pay-parking zone.

2. A computer-implemented method as in claim 1, wherein the pay-parking zone is a sign-less and meter-less parking zone, and wherein the physical notice further shows at least one of parking rates and parking rules for the pay-parking zone.

3. A computer-implemented method as in claim 2, further comprising changing at least one of the parking rates and the parking rules between a high parking season and a low parking season.

4. A computer-implemented method as in claim 1, further comprising communicating to a driver of the vehicle instructions for remotely making payment for parking the vehicle in the pay-parking zone, wherein the communicating comprises the physical notice placed on the vehicle and excludes mailing any notice to the owner of the vehicle.

5. A computer-implemented method as in claim 4, further comprising:
accessing historical information for the vehicle;
determining that the vehicle is delinquent in payment of at least one parking fee; and
generating the physical notice to reflect severity of the delinquency.

6. A computer-implemented method as in claim 1, further comprising:
recording, by the electronic storage, vehicle information for a second vehicle parked in the pay-parking zone;
determining, by the processor, that the second vehicle is associated with a landlord that is registered with the pay-parking zone, wherein the second vehicle is designated as a vehicle of a tenant of the landlord.

7. A computer-implemented method as in claim 1, further comprising:
recording, by the electronic storage, vehicle information for a second vehicle parked in the pay-parking zone; and
determining, by the processor, that the second vehicle is registered to park in the pay-parking zone.

8. A computer-implemented method as in claim 7, further comprising a second physical notice showing information regarding at least one of: special event, discount program, parade, parking policy change and construction, the second physical notice configured to be placed on the second vehicle.

9. A computer-implemented method as in claim 1, further comprising receiving, at the computer, an indication that the physical notice is validated by a merchant, wherein the payment transaction is made by the merchant for at least a portion of the payment.

10. A computer-implemented method as in claim 1, further comprising receiving, at the computer, an indication that responsibility for making payment for parking the vehicle in the pay-parking zone is to be handled by a particular entity, wherein the payment transaction is made by the particular entity.

11. A system for parking management, comprising:
an electronic storage that contains vehicle information for a vehicle parked in a pay-parking zone;
a processor configured to determine that the vehicle is not registered to park in the pay-parking zone;
a physical notice showing instructions for remotely making payment for parking the vehicle in the pay-parking zone, the payment to be made remote from the pay-parking zone, the physical notice configured to be placed on the vehicle; and
a computer configured to receive a payment transaction for parking the vehicle in the pay-parking zone, after the vehicle has left the pay-parking zone.

12. A system as in claim 11, wherein the pay-parking zone is a sign-less and meter-less parking zone, and wherein the physical notice further shows at least one of parking rates and parking rules for the pay-parking zone.

13. A system as in claim 12, wherein the parking rates comprise different rates between a high parking season and a low parking season and the parking rules comprising different rules between a high parking season and a low parking season.

14. A system as in claim 11, wherein the system excludes any mailing to the owner of the vehicle.

15. A system as in claim 14, wherein the processor is further configured to access historical information for the vehicle and determine that the vehicle is delinquent in payment of at least one parking fee; and
a parking personnel device configured to generate the physical notice to reflect severity of the delinquency.

16. A system as in claim 1, wherein:
the electronic storage further comprises vehicle information for a second vehicle parked in the pay-parking zone; and
the processor is further configured to determine that the second vehicle is associated with a landlord that is registered with the pay-parking zone, wherein the second vehicle is designated as a vehicle of a tenant of the landlord.

17. A system as in claim 11, wherein:
the electronic storage further comprises vehicle information for a second vehicle parked in the pay-parking zone; and
the processor is further configured to determine that the second vehicle is registered to park in the pay-parking zone.

18. A system as in claim 17, further comprising a second physical notice showing information regarding at least one of: special event, discount program, parade, parking policy change and construction, the second physical notice configured to be placed on the second vehicle.

19. A system as in claim 11, wherein the computer is further configured to receive an indication that the physical notice is validated by a merchant, wherein the payment transaction is made by the merchant for at least a portion of the payment.

20. A system as in claim 11, wherein the computer is further configured to receive an indication that responsibility for making payment for parking the vehicle in the pay-parking zone is to be handled by a particular entity, wherein the payment transaction is made by the particular entity.
